(19) United States
(12) Patent Application Publication
(10) Pub. No.: US 2009/0297787 A1
(43) Pub. Date: Dec. 3, 2009

(54) Method/Apparatus for Forming a Coated Optical Lens

(76) Inventors: Michael Hanney, Berkshire (GB); Christopher John Ferrari, Berkshire (GB); Des Gibson, Leicester (GB); John Michael Walls, Leicester (GB)

Correspondence Address: HEAD, JOHNSON & KACHIGIAN, 228 W 17TH PLACE, TULSA, OK, 74119, US

(21) Appl. No.: 12/224,354

(22) PCT Filed: Feb. 26, 2007
(86) PCT No.: PCT/GB2007/000663

§ 371 Date: Jun. 2, 2009

(30) Foreign Application Priority Data
Feb. 24, 2006 (GB) 0603734.5

(51) Int. Cl. B29C 45/00; B32B 1/00; G02B 1/11

(52) U.S. Cl. 428/174; 264/1.7; 425/542; 359/601

(57) ABSTRACT

The invention relates to the formation of optical lens including a coating, typically, an anti-reflective (AR) coating which provides improved characteristics of the lens. The invention provides for a method and apparatus for forming the coated lens in which there is provided a sheet material with the coating applied to at least one surface thereof. At least part of the sheet material is then placed into a mold and located so as to form an external surface of the lens, the base of which is formed by introducing, typically by injection, a material into the mold and during which molding process the material and sheet material join together to form the optical lens with the coating.

### CROSS-REFERENCES TO RELATED APPLICATIONS

This application is the United States National Phase of PCT/GB2007/000663 filed Feb. 26, 2007 which claims priority to British Application No. 0603734.5 filed Feb. 24, 2006 which are incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY REFERENCE OF MATERIAL SUBMITTED ON A COMPACT DISC

Not Applicable

### BACKGROUND OF THE INVENTION

The invention to which this application relates is to a method and apparatus which allows coated optical lens to be formed in a more effective and efficient manner than is presently the case.

The manufacture of optical lenses is done on a large scale operation worldwide. One type of lens is formed from polycarbonate, and coatings can be applied to the outer surface or surfaces of the lens so as to provide particular effects. For example, a material may be deposited onto an outer surface of the lens to provide an anti-reflective effect and/or a material may be applied as a layer to provide a hydrophobic effect which effectively discourages liquid adhering to the surface of the lens. Polycarbonate spectacle lenses are preferred because they have high impact resistance. This is particularly important in spectacles for children, for safety spectacles and for application in ball sports. It also has the advantage of having a relatively high refractive index (n=1.59) which makes the lenses thinner than a normal lens (n=1.5). Polycarbonate is notoriously easy to scratch and is normally never used without a hard coat.

The material which is applied to form the layers can be applied using various forms of apparatus including sputter deposition in which the lenses are placed into a chamber and material for forming the required coating is sputter deposited from a target or targets of the material mounted in conjunction with at least one magnetron within the coating chamber. While this is a conventionally used method and apparatus for applying the layers of material onto the lenses, the application processes which are used need to be tightly controlled in terms of the control of the deposited material, and other conditions within the chamber so as to allow the material to be applied to the lenses in a manner which allows the same to adhere to the surface of the lens and to be applied to form a uniform and even coating layer. The need for tight control is further increased by the fact that the external surfaces of the lens tend to be either concave or convex in shape, which means that the same are a relatively complex surface onto which the material is required to be deposited. This can be difficult to achieve and can result in many failures at the time of application of the layer or, even more problematically, the identification of failure some time after the coating and once the same are in use.

The aim of the present invention is to provide a method and apparatus which allows the creation of coated optical lenses in a manner which is more efficient and reduces the failure rate of the process.

### BRIEF SUMMARY OF THE INVENTION

In a first aspect of the invention there is provided a method for forming an optical lens having at least an anti-reflective coating layer applied to a surface thereof, the method comprising the steps of obtaining a sheet material to which an anti-reflective coating has been applied, placing at least a portion of the sheet material into a forming mold into which a further material for forming the base of the lens is introduced, and joining the sheet material with the further material to form the same into the required lens shape.

In one embodiment, the method includes the step of applying the anti-reflective coating material to a surface of the sheet material and then cutting the sheet material to form one or more coupons of dimension to be fitted into the mold.

In one embodiment, the material which is introduced into the mold is of the same or similar composition to the sheet material used to form the coupon such that the material fuses under the application of heat to form a unitary lens body.

In one embodiment, the sheet material is presented to the coating apparatus with the surface to be coated perpendicular to the direction of application of the coating material. Alternatively, the sheet material may be uniformly curved such as, for example, the same having been wrapped around a cylindrical carrier.

Typically, the sheet material is of a size to allow a plurality of coated coupons to be cut therefrom. In one embodiment, the coating layer or layers which are applied, include one or any combination of an anti-reflective (AR) coating and/or a hydrophobic coating and/or a hard coating. Typically, the hard coating layer is always applied.

When a hydrophobic coating is applied this has two functions. First, it makes the lens easy to clean since it has a low surface energy and, secondly, its low surface energy also acts as a mold release in the injection molding tool.

In one embodiment, when forming the optical lens, two coupons are provided in a spaced relationship, a first coupon provided to one side of the mold to form a front face of the lens, and a second coupon provided to the opposing side of the mold to form the rear face of the lens such that the additional material is introduced into the mold to join or fuse with the coupons to form a base but not the front or rear surfaces of the lens.

In an alternative embodiment, no new material is introduced and the two coupons are joined together.

In one embodiment, the coupons which are used to form the front and rear surfaces may have different coatings applied thereto.

In each case, the coupons are presented in the mold such that the surfaces of the same which have the coating applied thereto face externally of the mold and hence form the external surfaces of the formed optical lens.

Typically, the molding process which is used is injection molding with the material used to form the base of the optical lens introduced in a liquid, heated form and with heat being applied in a controlled manner such that the faces of the coupon or coupons which face internally of the mold are also heated to a sufficient extend so as to fuse with the material which is introduced into the mold and therefore join the same together.

In one embodiment, any suitable material deposition or application means can be used to apply material onto the sheet material to coat the same.

In one embodiment, the AR coated coupon to be used to form the front surface of the lens may be combined with a photochromic material to form a low reflecting photochromic lens.

In one embodiment, sun wear optical lenses can be formed which can consist of a front surface reflective coating and tinted bulk lens material. For highest quality, an AR coating is applied to the back surface of the lens.

Typically, the reflective front surface is often made with a fashionable color. Reflective coatings can be single layer metal layers or multilayer coatings with low and high refractive index materials of suitable thickness.

In this case, a reflective mirror coupon would be extracted from the reflective coated sheet and an AR coated coupon is used for the back surface.

The front surface mirror coupon may be combined with a photochromic coupon to provide decreasing light transmission with increasing ambient light intensity.

In a further aspect of the invention, there is provided a method for forming an optical lens with an anti-reflective coating on at least one surface thereof. The method comprising the steps of using sheet material, or a coupon cut therefrom, which a surface to which the anti-reflective coating is applied, joining the sheet material or coupon to a lens base, wherein the base is formed by injecting a further material into a mold in which the coupon or sheet material is held in the required location, and applying heat and/or pressure to cause the coupon or sheet material and further material to join together to form the lens.

In one embodiment the material for the lens base and sheet is polycarbonate.

In one embodiment, the material for the lens is injection molded into a mold in which at least one sheet or coupon is mounted and joins therewith to form the optical lens.

In a further aspect of the invention, there is provided apparatus for the formation of an optical lens having an anti-reflective coating. The apparatus includes a mold, location means in the mold for locating at least one coupon of sheet material having an anti-reflective coating applied thereto in position so as to form an external surface of the lens, injection means for injecting a fluid material into the mold to form the base of the lens and to fuse with the coupon or sheet material and form the lens.

In one embodiment, two sheets or coupons are held in the mold and the additional material is injected into, and forms the base, between the same.

In one embodiment, the anti-reflective coating is applied to a sheet of material using a coating chamber in which the sheet material is placed, at least one target of material which is to be sputter deposited onto the sheet material to form a layer thereon, and at least one magnetron is provided so as to cause the sputter deposition of material from the target. In one embodiment, a plurality of magnetrons and/or magnet arrays are provided in the coating chamber in a closed field configuration.

Typically, the mold causes the sheet material or coupon(s) to be moved from a substantially flat condition to a curved condition. If the coupon forms the front surface of the formed optical lens, the external surface of the coupon takes a convex shape and if the coupon forms the rear side of the lens the external surface of the coupon takes a concave shape.

In a yet further aspect of the invention, there is provided an optical lens having a base. The lens has at least one outer coated surface, and the coatings are applied to a sheet or coupon of material which is joined or fixed with the lens base.

In one embodiment, the optical lens is formed from polycarbonate material.

### BRIEF DESCRIPTION OF THE DRAWINGS

Specific embodiment of the invention will now be described with reference to the accompanying drawings.

FIGS. 1 and 2 illustrate coating apparatus which can be used in accordance with the invention in one embodiment.

FIG. 3A illustrates a mold which can be used in conjunction with the invention.

FIG. 3B illustrates a cross section of a lens formed in accordance with the invention.

FIG. 4 illustrates in schematic manner the steps of the method in accordance with one embodiment of the invention.

### DETAILED DESCRIPTION OF THE INVENTION

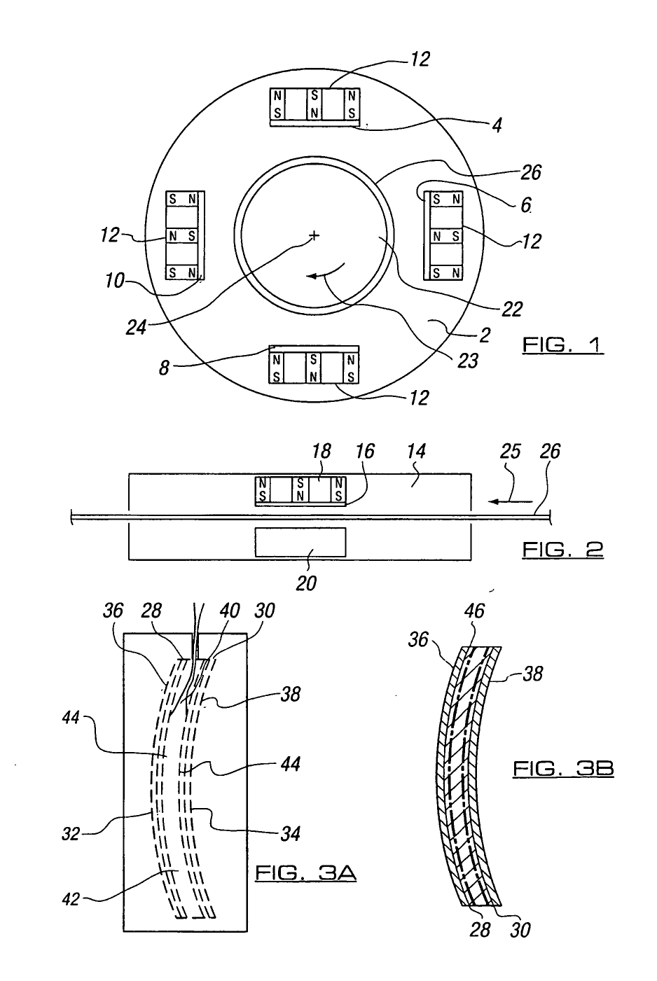

Referring first to FIGS. 1 and 2, there is illustrated a rotatable cylinder and flat in line coating apparatus respectively. A closed field magnetron sputter deposition apparatus is shown in FIG. 1 which comprises a coating chamber 2 in which there is provided two target 4, 6, 8, 10 of a material to be sputter deposited and magnetrons 12 which have magnetic arrays formed and located, with the magnet polarities configured with respect to the other magnetrons as illustrated. Control means are provided to control other parameters of operation of the apparatus such as, for example, an anti-reflective coating and/or a hydrophobic coating and/or a hard coating to be applied by selective sputter deposition of materials from the targets 4, 6, 8, 10 in selected gases or plasma. FIG. 2 illustrates a coating chamber 14 with a target of material 16 and magnetron 18 and magnet array 20 again configured to allow the sputter deposition of material from the target, but in this case the sheet material passes in the direction or arrows 25.

The material to be coated is a sheet material 26 which, in FIG. 1, is wrapped around carrier 22 which is rotatable about axis 24, as shown by arrow 23, and, in FIG. 2 is provided in a flat condition as shown. In accordance with the invention, the material is sputter deposited onto one of the surfaces of the sheet material to form a coating across the same.

Once the coating has been applied, one or a series of coupons of the desired size are typically cut from the sheet material, the coupons cut to a shape to allow the same to be used to form an optical lens external surface.

The material which is applied to the sheet material can be selected, in one embodiment, to form a multi-layered coating of a hard coating, anti-reflective coating and hydrophobic coating forming the outer surface. Typically, the sheet material is of a polycarbonate material.

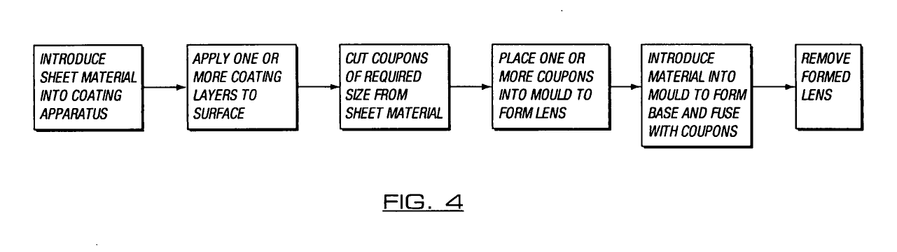

The coupon or coupons 28, 30 to be used for each optical lens are then placed into a mold 32 shown schematically in FIG. 3. In this case, a lens is to be formed which has both the front 32 and rear face 34 formed by the external coatings 36, 38 respectively, which are shown to be of an exaggerated depth for the purposes of illustration.

Each coupon is mounted in the mold such that the face of the same, which is provided with a coating layer, faces outwardly of the mold as illustrated. Heat is then applied, and a liquid material 40, typically also polycarbonate, is introduced into the cavity 24 between the coupons in the mold. The material which is introduced will effectively form the base of the optical lens and, heat. which is applied both via the liquid material which is introduced and perhaps also external heating and/or pressure, causes the internally facing surfaces 44 of the coupons, to partially melt and fuse with the material 40, which is introduced into the mold to therefore form a unitary optical lens.

In addition, the coupons are also held in the required shape in the mold such that the outer surface 32 of the front face of the optical lens which is formed has a convex shape and the external face 34 of the rear face of the optical lens which is formed has a concave shape as shown in FIG. 3b which shows a cross section through a lens formed in accordance with the invention. Thus, there is formed an optical lens 46 which has the required optical characteristics and which has coating layers applied thereto as required, but as the coating layers are applied when the sheet material is in a flat condition, the layers can be applied more efficiently and with reduced failure rate. It is also found that the molding of the coupons, which are subsequently formed of the sheet material, does not adversely affect the coating layer as long as the molding is properly controlled.

The various steps of the method are therefore illustrated with regard to FIGS. 3-4 and the following specific example of the process.

In this process, stock, hard coated polycarbonate sheet is procured. The sheet is typically of a thickness in the range of 100 um-500 um thick. A hard coat layer is applied to the sheet to a thickness in the range 2 um to 20 um. The hard coat may be UV-cured or thermally cured. It can be applied using spray or dip techniques.

An AR coating is applied to the sheet by wrapping an area around a vertical carrier drum of the type shown in FIG. 1a and applying the AR using reactive magnetron sputtering. Although the drum geometry is ideal for this purpose, the AR coating may also be applied using other PVD techniques such as electron beam evaporation. Moreover, plasma enhanced chemical vapor deposition of AR coating can be utilized as an alternative to PVD. For very high volumes, the AR coating may be deposited using in-line systems or roll-to-roll deposition equipment.

The AR coating usually comprises four (or more) layers of alternate low index and high index metal oxides. Silicon dioxide is usually chosen as the low index material, while the high index material is usually chosen from the oxides of Nb, Hf, Zr, Ta, Ti or silicon nitride or oxynitride. A transparent electrically conducting oxide such as ITO may also be used to provide anti-static properties.

The hydrophobic deposition may also be a vacuum process. Typically, a pre-formed “hydrophobic pill” is thermally evaporated after the AR coating has been deposited to form a thin polymeric coating on the outer surface. The hydrophobic coating is water repellent and usually exhibits a water contact angle exceeding 100 deg. These coatings also usually exhibit oleophobic behavior making the lens easier to clean. The hydrophobic coating makes the lens water repellent.

Once the sheet has been coated, it is cut into a number of “coupons”. These coupons can have three (or more) tabs to help their subsequent location in the mold. A coupon is placed in the front and the back of the injection molding, too. The coupon positioning can be manual or automatic. The lens is produced by injecting polycarbonate into the molding tool. The mold has a specific shape corresponding to a specific lens power and prescription. The injected polycarbonate fuses with the coupons to form a coated lens in one operation.

It is important that the hard coating and the AR coating have low stress so that cracking is avoided in the hot injection molding process. It should also be noted that the specific method of applying the coatings need not necessarily be followed and that other coating methods may alternatively be used. Indeed, it may be possible to obtain suitable coated sheet material from a third party and then use it in conjunction with the mold and method in accordance with the invention.

The invention can be applied to single vision lenses using molds. The equipment can be single shot for use by a small laboratory or multiple shot for a large manufacturer. Astigmatic lens requirements can be met with a rotational adjustment. The technology may also be applied to special varifocal or progressive lenses by making available a range of appropriate tooling over a suitable range of dioptres (positive and negative).

In one embodiment, if a hydrophobic layer is applied to the sheet material and forms an outer surface of the lens in the mold, the same aids the release of the formed lens from the mold. A further advantage is that polycarbonate material is prone to scratching, which can cause high failure rates during movement of the conventional lens prior to coating. However, in accordance with this invention, the coatings are applied prior to the lens being formed and moved and, therefore, act to reduce the damage from scratching as they act as protective layers for the polycarbonate material. Thus, the yield problems which conventionally occur between forming the lens and hard coating because of handling are eliminated or reduced. Furthermore, as the coated lens is formed in one operation, this avoids handling the polycarbonate which is notoriously easy to scratch, cleaning the polycarbonate prior to hard coating, hard coating (dip or spin), AR coating and then hydrophobic coating. Once formed, the lens is ready to be edged for a spectacle lens or shipped to a prescription laboratory.

The process is cost saving and time saving and eliminates the need for separate ultrasonic cleaning apparatus lines, dip or spin hard coating apparatus lines and vacuum based PVD equipment for AR and hydrophobic coatings.

1. A method for forming an optical lens having at least an anti-reflective coating layer applied to a surface thereof, said method comprising the steps of:
obtaining a sheet material to which an anti-reflective coating has been applied;
placing at least a portion of the sheet material into a forming mold into which a further material for forming the base of the lens is introduced; and
joining the sheet material with the further material to form the same into the required lens shape.

2. The method according to claim 1 wherein the material which is introduced into the mold is of the same of similar composition to the sheet material used to form the coupon such that the sheet material and further material fuse under the application of the heat to form a unitary lens body.

3. The method according to claim 1 wherein the method includes the step of applying the anti-reflective coating to a surface of said sheet material and then cutting the sheet material into one or a plurality of coupons of a dimension to be placed into said mold.

4. The method according to claim 3 wherein said sheet material is presented to the coating apparatus with the surface to be coated perpendicular to the direction of application of the coating material.

5. The method according to claim 3 wherein said sheet material is uniformly curved during the application of the coating material.

6. The method according to claim 5 wherein the sheet material is wrapped around a cylindrical carrier.

7. The method according to claim 3 wherein said sheet material is of a size to allow a plurality of coated coupons to be cut therefrom.

8. The method according to claim 1 wherein the sheet material includes any or both of a hydrophobic coating and/or a hard coating.

9. The method according to claim 1 wherein two coupons of sheet material are provided in a spaced relationship, a first coupon provided to one side of the mold to form a front face of the lens and a second coupon provided to the opposing side of the mold to form the rear face of the lens and the further material is introduced into the mold to join or fuse with the coupons to form a base but not the front or rear surfaces of the lens.

10. The method according to claim 9 wherein the coupons which are used to form the front and rear surfaces have the same or different coatings applied thereto.

11. The method according to claim 1 wherein a coupon is presented in the mold such that the surface of the same which has the coating applied thereto faces externally of the mold and hence forms an external surface of the formed optical lens.

12. The method according to claim 1 wherein the further material is introduced by injection molding with the material introduced in a liquid form.

13. The method according to claim 12 wherein the further material is heated and heat is applied in a controlled manner such that the faces of the coupon or coupons which face internally of the mold are also heated to a sufficient extent so as to fuse with the material which is introduced into the mold and therefore join the same together.

14. The method according to claim 1 wherein a coating is applied to the sheet material to provide an anti-reflective coating and said further material is a photochromic material to form a low reflecting photochromic lens.

15. The method according to claim 1 wherein there is provided a lens formed of a base of tinted further material and having front and/or rear external faces formed with an anti-reflective coating via coupons of the sheet material bonded with the base.

16. The method according to claim 1 wherein a first coupon is applied to form a front surface of the lens with a reflective coating, and a second coupon is applied to form a rear surface of the lens with an anti-reflective coating.

17. The method according to claim 16 wherein the coupon with the reflective coating is combined with a photochromic coated coupon to provide decreasing light transmission with increasing ambient light intensity.

18. A method for forming an optical lens with an anti-reflective coating on at least one surface thereof, said method comprising the steps of:
using sheet material, or a coupon cut therefrom, with a surface to which the anti-reflective coating is applied;
joining said sheet material or coupon to a lens base, wherein said base is formed by injecting a further material into a mold in which the coupon or sheet material is held in the required location; and
applying heat and/or pressure to cause the coupon or sheet material and further material to join together to form the lens.

19. The method according to claim 18 wherein the material for the lens base and sheet is polycarbonate.

20. The method according to claim 18 wherein the material for the lens base is injection molded into a mold in which at least one sheet or coupon is mounted and joins therewith to form the optical lens.

21. Apparatus for the formation of an optical lens having an anti-reflective coating, said apparatus comprising:
a mold;
location means in the mold for locating at least one coupon of sheet material having an anti-reflective coating applied thereto in position so as to form an external surface of said lens; and
injection means for injecting a fluid material into the mold to form the base of the lens and to fuse with the coupon or sheet material and form said lens.

22. Apparatus according to claim 21 wherein two sheets or coupons are held in the mold in a spaced relationship and the further material is injected into and forms the base between the same.

23. Apparatus according to claim 21 wherein a plurality of magnetrons and/or magnet arrays are provided in a coating chamber in which the sheet material is placed so as to be coated with the anti-reflective coating forming materials.

24. Apparatus according to claim 23 wherein the magnetrons and/or magnet arrays are provided in a closed field configuration.

25. Apparatus according to claim 21 wherein the mold causes the sheet material or coupon(s) to be moved from a substantially flat condition to a curved condition.

26. Apparatus according to claim 25 wherein if the coupon forms the front surface of the formed optical lens, the external surface of the coupon takes a convex shape and if the coupon forms the rear side of the lens, the external surface of the coupon takes a concave shape.

27. An optical lens having a base, said lens having at least one outer anti-reflective coated surface preformed on a sheet material which is joined or fixed with the lens base in accordance with the method as herein described.
